(19) United States
(12) Patent Application Publication
(10) Pub. No.: US 2008/0040463 A1
(43) Pub. Date: Feb. 14, 2008

(54) Communication System for Multiple Chassis Computer Systems

(75) Inventors: Deanna Lynn Quigg Brown, Queen Creek, AZ (US); Ivan Ronald Olguin, Tucson, AZ (US)

Correspondence Address: QUARLES & BRADY LLP, 1 SOUTH CHURCH AVENUE, SUITE 1700, TUCSON, AZ, 85701, US

(73) Assignee: INTERNATIONAL BUSINESS MACHINES CORPORATION, Armonk, NY (US)

(21) Appl. No.: 11/463,151

(22) Filed: Aug. 8, 2006

(51) Int. Cl. G06F 15/16; G06F 15/173; H04B 7/212

(52) U.S. Cl. 709/223; 370/347; 709/208; 709/250

(57) ABSTRACT

A system for providing communication between chassis in a computer system includes a plurality of management modules connected by a communication path. A first module is configured as a master module and the remainder of the plurality is configured as slave modules. A single module is located within each chassis in the computer system. The slave modules gather information from a component within a specific domain of the slave modules. The slave modules send the information to the master module. The master module organizes the information to form a representation of a topology of the plurality of management modules. A method for providing communication between multiple chassis in a computer system includes gathering information from a component within a specific domain of the management module. The information is then sent from a slave management module to a master management module where the information is organized.

### BACKGROUND OF THE INVENTION

1 . Field of the Invention

The present invention relates in general to computers, and, more particularly, to a system and method of managing hardware subsystems that span across multiple, “blade” form factor chassis.

2. Description of the Prior Art

In computer systems having a “blade” form factor, such as IBM® BladeCenter® computer systems, current computer architecture does not generally provide for communication between computer subsystems integrated into two different chassis, or for communication between computer subsystems using external components. This complicates the management environment by requiring that a customer fully understand the overall topology of the computer system and fully understand how subcomponents of the computer system such as blades or modules across varying chassis and external hardware will interact with each other.

If a hardware component or subcomponent within the system topology loses connectivity with another chassis or external hardware component that the hardware is dependent on communicating with, the lack of communication between computer subsystems becomes problematic to users, who must decipher the topology of the computer system to resolve the problem. Additional time and resources are spent resolving the problem.

Thus, there is a need for a system and method of communication between computer subsystems integrated into different chassis. Additionally, there is a need for a system and method of communication between computer subsystems using external components. The implementation should take advantage of existing hardware and firmware in the computer system to reduce cost and complexity of the implementation.

### SUMMARY OF THE INVENTION

In one embodiment, the present invention is a system for providing communication between chassis in a computer system, comprising a plurality of management modules connected by a communication path, a first module configured as a master module and the remainder of the plurality configured as slave modules, a single module located within each chassis in the computer system, wherein the slave modules gather information from a component within a specific domain of the slave modules, the slave modules send the information to the master module, and the master module organizes the information to form a representation of a topology of the plurality of management modules.

In another embodiment the present invention is a method for providing communication between multiple chassis in a computer system, each chassis including a management module connected by a communication path, comprising gathering information from a component within a specific domain of the management module, sending the information from a slave management module to a master management module to provide a central repository for the information, and organizing the information to form a representation of the topology of the multiple chassis of the computer system.

In another embodiment, the present invention is a method for providing communication between multiple chassis in a computer system, each chassis including a management module connected by a communication path, comprising determining whether a hardware subcomponent of the computer system has a dependency when a requested function is received by a master management module, wherein if a dependency is determined to have been made, the master management module queries a slave management module responsible for the dependency to perform verification, the slave management module sends information to the master management module identifying a status of the domain of the slave module, and the master management module displays the status information to a user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to he limiting of its scope, the invention will be described and explained with additional specificity and detail through the use of the accompanying drawings, in which:

FIG. 1 illustrates an example architecture of a typical server for operation in a computer system, the server having a “blade” form factor;

FIG. 2a illustrates an example controller blade for operation in a computer system;

FIG. 2b illustrates an example storage blade for operation in a computer system;

FIG. 3 illustrates an example system for providing communication between chassis in a computer system;

FIG. 4 illustrates an example method for providing communication between chassis in a computer system; and

FIG. 5 illustrates an example method for providing communication between chassis in a computer system;

### DETAILED DESCRIPTION OF THE DRAWINGS

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a lernoulli drive, a magnetic disk, a punch card, flash memory, integrated circuits, or other digital processing apparatus memory device.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

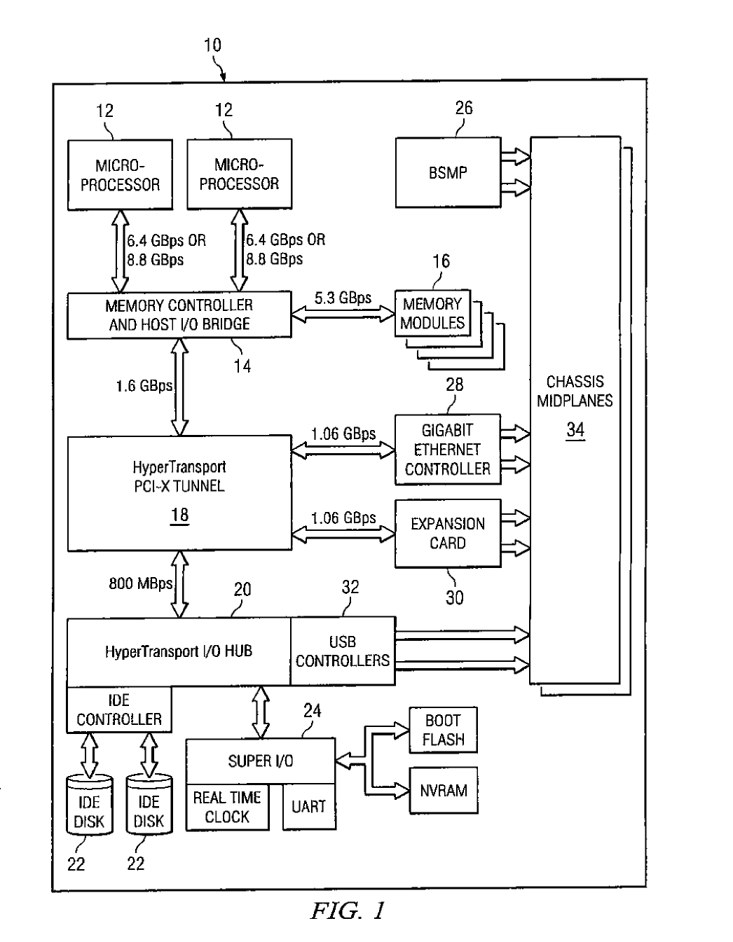

Turning to FIG. 1, an example architecture of a typical blade server 10 for operation in a computer system is shown. Buses, interfaces, or similar connections between components are depicted with arrows as shown, as are example data rates. The server 10 includes dual microprocessors 12, a memory controller and I/O bridge 14, onboard memory 16, PCI interface 18, I/O hub 20 and IDE disks 22. Blade server 10 includes subcomponents as part of the BIOS 24. Various components of server 10 enable server 10 to communicate with external components in the larger computer system in which server 10 is designed to operate. Ethernet controller 28, expansion card 30, USB controllers 32 and a blade server management processor (BSMP) are shown coupled to chassis midplanes 34. Chassis midplanes 34 serve as connection points for a plurality of servers 10 to a larger overall computer system. For example, a number of servers 10 containing microprocessors, or processor blades can be connected to a plurality of chassis midplanes 34. Chassis midplanes 34 can be mounted to a chassis. An individual chassis or several chassis can then be mounted in a rack mount enclosure. In addition to processor blades comprising servers 10, blades which carry control or storage devices are contemplated. A variety of generic high speed interfaces can be wired or otherwise coupled to chassis midplanes 34.

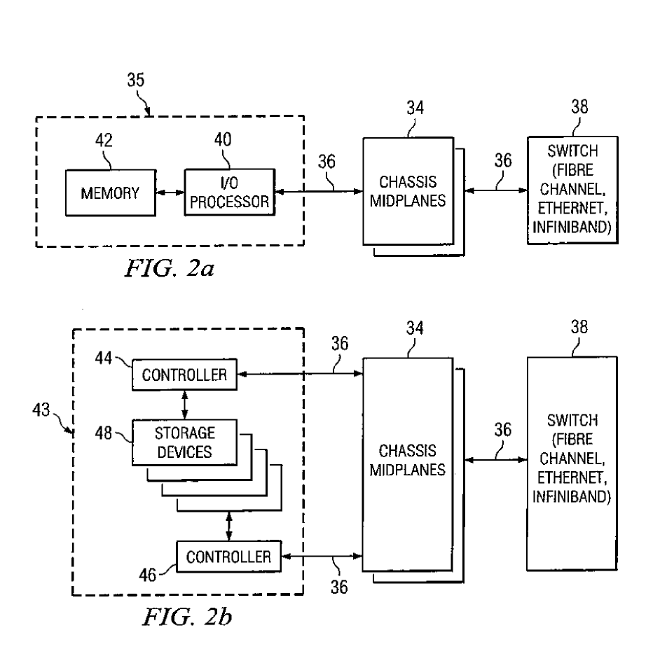

FIG. 2a illustrates an example RAID controller blade 35 which can be integrated into the chassis by coupling to midplanes 34. A generic high speed fabric or interface 36 can connect controller blade 35 to a switch 38. Switch fabrics 36 are integrated into the midplanes 34. Switch fabrics 36 can facilitate the transfer of a plurality of high speed signals routed from each of the blade slots in the rack mount enclosure to a set of switches 38 that are installed in the rear of the chassis. The midplane 34 wiring 36 is generic in the sense that a user can install different switch modules to personalize the fabric for a specific technology that the blades support, e.g. fiber channel switches, Ethernet switches or Infiniband switches. A Serial Attached SCSI (SAS) switch can be used to interconnect the blades to SAS storage which can be located on a separate blade in the system.

Referring again to FIG. 2a, controller blade 35 includes I/O processor 40 which is coupled to memory 42. Interface 36 couples controller blade 35 with midplane 34. Controller blade 35 can operate in a manner similar to typical RAID controllers. Control blade 35 can determine which of a plurality of storage devices is to receive data. The data can then be sent to the appropriate device. While a first device is writing the data, controller blade 35 can send a second portion of data to a second device. Controller blade 35 can also read a portion of data from a third device. Simultaneous data transfers made possible by controller 35 allow for faster performance.

FIG. 2b illustrates an example storage blade 43 which can be integrated into the chassis by coupling to midplane 34. Again, high speed fabric 36 is shown coupling switch 38 to midplane 34. Additionally, storage blade 43 is coupled by interfaces 36 to midplane 34. Controller 44 and controller 46 are depicted as local to storage blade 43. Controllers 44 and 46 are coupled to a plurality of storage devices 48. Storage devices 48 can be an array of disk drives, such as a “Just-a-Bunch-Of-Drives” (JBOD) topology.

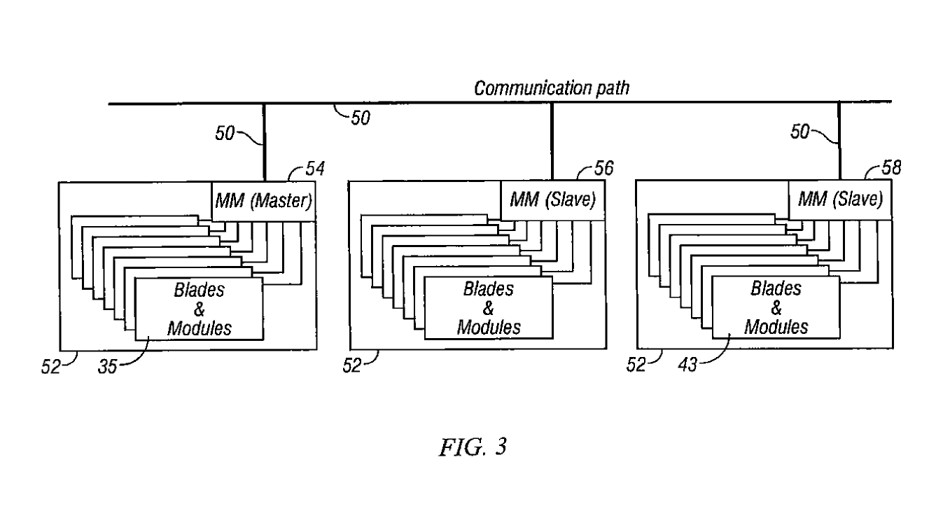

FIG. 3 depicts an example system for providing communication between chassis in a computer system. A signal bearing medium, in this case a communication path 50, having a protocol such as Ethernet, RS485, or similar is shown. A plurality of chassis 52 are shown linked by path 50. Chassis 52 include controller blade 35, and storage blade 43 as shown. A host of blades and other modules are incorporated into a single chassis 52. Each blade or module is linked to management module (MM). Each chassis 52 includes a management module. The management module can be a master module 54, or can be one of a plurality of slave modules 56, 58. Additionally, a management module can be located as part of an external management server or other component which is not physically located on chassis 52, forming an external hardware component, such as an external JBOD, external controller, or even an external server.

Modules 54, 56, 58 can include a logic control entity which can operate alternatively as software, hardware or a combination of software and hardware on the computer system. Modules 54, 56, 58 can include such software as a device driver routine or similar software which acts as an interface between applications and hardware devices. Modules 54, 56, 53 can be implemented in the computer system as hardware using Very High Speed Integrated Circuit (VHSIC) Hardware Description Language (VHDL). Module 54, 56, 58 can be implemented in the computer system as software which is adapted to operate under a multitasking operating system such as UNIX, LIN, or an equivalent. Finally, modules 54, 56, 58 can be configured to be scalable to operate on an enterprise computer system or incorporate enterprise system communications technology such as ESCON or an equivalent.

The present invention expands the capabilities of current architectures which only allow a user to manage blades/modules within a single chassis 52. A user can manage multiple chassis 52 and external hardware by defining the relationship between each component. A user can centrally manage a server/storage environment with multiple chassis 52 and external hardware components using a master module and multiple slave module topology. Again, the present invention contemplates management of external components such as JBODs, controllers, or servers incorporating the described topology.

Slave modules 56, 58 can be responsible for gathering information from components with the specific domain of the slave module 56, 58 such as the status of the component and the location of the component in the domain. The slave modules 56, 58 can then send the information to the master module 54. The master module 54 uses the information to generate a graphical representation of the overall topology of the management pool. The master module 54 then becomes the central repository for the information gathered from the slave modules 56, 58 or slave modules located on external components of the computer system.

Having all the information stored on master module 54 works to minimize the amount of traffic on the communication path 50, which improves performance. Master module 54 can use the information in the repository to determine if a particular hardware component has a specific dependency when a requested function is received by the master module 54. Several situations such as a processor boot from a particular storage-area-network (SAN), various switch modules and storage expansions in the overall system can cause a hardware component dependency. The management pool can use several communication methods such as out-band (e.g., Ethernet VLAN) or in-band (e.g., SAS fabrics) which can all be funneled into a central management pool interface, again having a protocol such as Ethernet RS485 or similar.

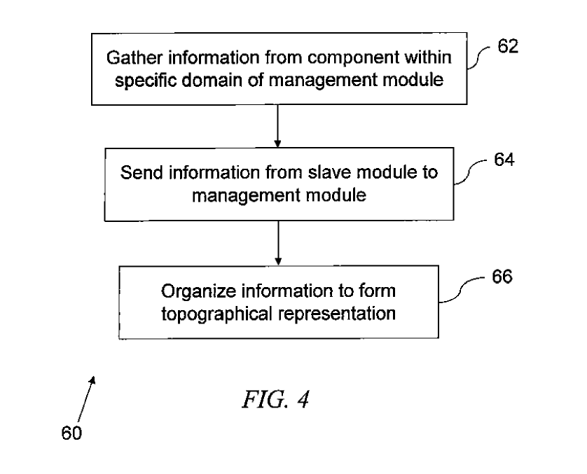

FIG. 4 depicts an example method 60 of providing communication between chassis in a computer system, the method performed using a management pool network as described having a plurality of management modules configured as described. First, the management modules gather information from various components within the specific domain of the particular management module, be it slave or master (step 62). The information, again, can include such data as status or location information. The information is sent from slave management modules over the communication path to the master management module (step 64). The master management module then organizes the information to form a graphical representation of the topology of the computer system (step 66).

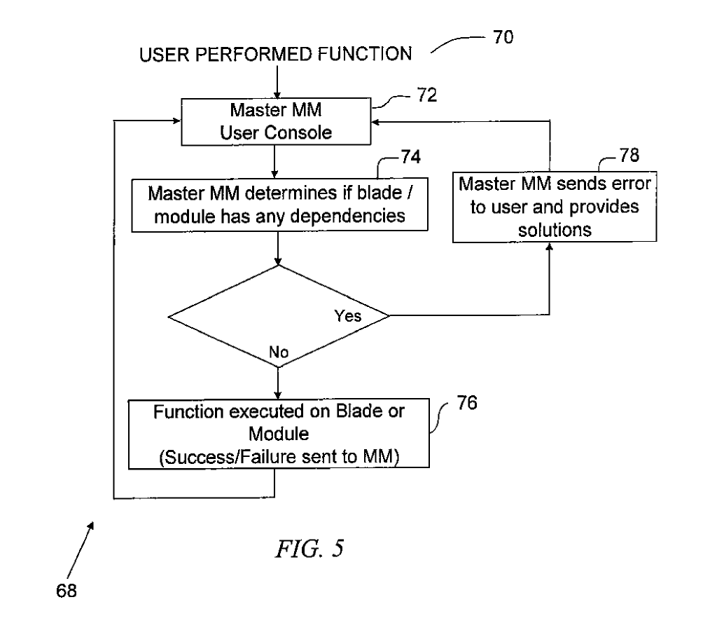

Turning to FIG. 5, an example method 68 of operation of a system for providing communication between multiple chassis in a computer system is seen. As a first step, a user-performed function takes place (step 70). The master management module is informed of the function (step 72). The master management module then makes a determination whether any blade or module has a dependency based on the function performed (step 74). If no, the function is executed on the blade or module in the computer system. The success or failure of the function is then communicated back to the master management module (step 76). If yes, the master management module sends an error to the user via a user console in the module, and provides a list of solutions to the error received (step 78).

To illustrate method 68, consider the following example operation of a communication system for a multiple chassis computer system with external components. A user first connects to the master management module in chassis #2 and attempts a power-on operation of a blade in chassis #3, slot 5 in the computer system. The master management module then accesses its central repository of information to determine if the blade has any dependency on other blades or modules within the management pool (refer to FIG. 3). The master management module determines tat the blade does have a dependency on a blade in chassis #5, slot #13. As a result, the master management module queries the slave management module in chassis #5 to verify that it satisfies the requirements of the blade in chassis #2.

As a next step, chassis #5 responds to the master management module that the blade in slot #4 is powered off. The master management module then displays an error message to the user which indicates the details of why the blade cannot be powered on. For example, the message could read: “Error: Blade in Chassis #3, Slot #5 Cannot Be Powered On. . . . The Blade In Chassis #3, Slot #4 Must Be Powered On First”. The master management module then provides a list of options that a user can perform. The first option would be to ignore the dependency and continue to power on the blade in chassis #3. The second option would allow the user the option of powering on the blade in chassis #5 and then powering on the blade in chassis #3, subject to the error condition.

If the second option is chosen by the user, the master management module than performs a second verification process on the blade in chassis #5 to again determine any dependencies and/or check the status of the blade.

Implementing and utilizing the example systems and methods as described can provide a simple, effective method of providing communication between multiple chassis in a computer system. While one or more embodiments of the present invention have been illustrated in detail, the skilled artisan will appreciate that modifications and adaptations to those embodiments may be made without departing from the scope of the present invention as set forth in the following claims.

What is claimed is:

1. A system for providing communication between chassis in a computer system, comprising:
a plurality of management modules connected by a communication path, a first module configured as a master module and the remainder of the plurality configured as slave modules, a single module located within each chassis in the computer system, wherein:
the slave modules gather information from a component within a specific domain of the slave modules,
the slave modules send the information to the master module, and
the master module organizes the information to form a representation of a topology of the plurality of management modules.

2. The system of claim 1, wherein the master module operates to minimize traffic on the communication path.

3. The system of claim 1, wherein the plurality of management modules is compliant with a Serial Attached SCSI (SAS) specification.

4. The system of claim 1, wherein the plurality of management modules is compliant with a Serial Advanced Technology Attachment (SATA) specification.

5. The system of claim 1, wherein the master module synthesizes the information to determine if a hardware subcomponent of the computer system has a dependency when a requested function is received by the master module.

6. The system of claim 1, wherein the plurality of management modules is implemented as a logic control entity operating alternatively as software, hardware or a combination of software and hardware on the computer system.

7. The system of claim 1, wherein the plurality of management modules utilize an out-band or in-band communication method which is funneled into a central interface operating on the computer system.

8. A method for providing communication between multiple chassis in a computer system, each chassis including a management module connected by a communication path, comprising:
gathering information from a component within a specific domain of the management module;
sending the information from a slave management module to a master management module to provide a central repository for the information; and
organizing the information to form a representation of the topology of the multiple chassis of the computer system.

9. The method of claim 8, further including minimizing traffic on the communication path by the master management module.

10. The method of claim 8, further including synthesizing the information to determine if a hardware subcomponent of the computer system has a dependency when a requested function is received by the master management module.

11. The method of claim 8, wherein sending the information from a slave management module to a master management module is performed with an out-band or in-band communication method which is funneled into a central interface operating on the computer system.

12. A method for providing communication between multiple chassis in a computer system, each chassis including a management module connected by a communication path, comprising:
determining whether a hardware subcomponent of the computer system has a dependency when a requested function is received by a master management module, wherein if a dependency is determined to have been made:
the master management module queries a slave management module responsible for the dependency to perform verification,
the slave management module sends information to the master management module identifying a status of the domain of the slave module, and
the master management module displays the status information to a user.

13. The method of claim 12, wherein the master management module provides a plurality of options for a user to perform based on the dependency.

14. The method of claim 13, wherein one of the plurality of options includes ignoring the dependency.

15. The method of claim 12, wherein the slave management module sends information to the master management module using an out-band or in-band communication method funneled into a central interface of the computer system.

16. The method of claim 12, wherein each of the management modules is compliant with a Serial Attached SCSI (SAS) specification.

17. The method of claim 12, wherein each of the management modules is compliant with a Serial Advanced Technology Attachment (SATA) specification.

18. The method of claim 12, wherein each of the management modules is implemented as a logic control entity operating alternatively as software, hardware or a combination of software and hardware on the computer system.
